(19) United States
(12) Patent Application Publication
(10) Pub. No.: US 2011/0211805 A1
(43) Pub. Date: Sep. 1, 2011

(54) BY STANDER-ACTIVATED AUDIO/VIDEO DISPLAY WITH REPLACEMENT MEMORY

(75) Inventor: Michael Abrahamson, Chicago, IL (US)

(73) Assignee: PYRAMID pRODUCTIONS ,INC., Chicago, IL (US)

(21) Appl. No.: 13/059,205

(22) PCT Filed: Aug. 15, 2008
(86) PCT No.: PCT/US2008/073342

§ 371 Date: May 4, 2011

(51) Int. Cl. H04N 5/91

(52) U.S. Cl. 386/230; 386/E05.028

(57) ABSTRACT

A motion-sensing sales display, which plays back video and/or audio programming whenever a bystander enters the area in front of the display, is provided. An electronic motion sensor detects the presence of a nearby bystander and electrically triggers a digital media playback device, which plays back video and/or audio program materials stored in the display's digital memory. A video monitor and speaker integrated into the face of the display allow the sales display to present the recorded programming without the need for external audiovisual components.

### FIELD OF THE INVENTION

The instant disclosure relates to a motion activated point-of-purchase (POP) display capable of playing back sound and/or video, and more particularly, to a POP display having means for detecting motion of a human observer (“bystander”) in proximity to the POP display. When the sensor detects the bystander's presence, it then triggers sound, video, or both in harmony, which can then be viewed and/or heard by the bystander.

### GENERAL DESCRIPTION OF THE INVENTION

Display stands have commercial value in “point-of purchase” (POP) retail sales locations. Traditional displays consisted primarily of static stands and signage. The interactive POP display described herein has the added capability to project to the observer an audio clip alone or in synchrony with a video clip. The audio and/or visual program is initiated by a motion sensor, which detects the bystander's presence near the POP display. The use of audio and video in the POP display attracts the bystander's attention and enhances the appeal of the display's product, even attracting the attention of bystanders who may have ignored a static display. Switches or pushbuttons may be provided on the display which can be selectively actuated and controlled by the bystander or sales representative when near the display, allowing the bystander or the sales representative to restart or stop the audio and video program playing on the POP display, as desired.

The interactive POP display typically includes the following components:

1) A base or stand, which within it has components capable of selectively playing pre-recorded audio and a pre-recorded video clip, separately or synchronized with one another.

2) A sign, which consists partially or entirely of a flat-panel video monitor for display of the pre-recorded video clip. If a more compact design is desired, the sign may be integrated into the front face of the base or stand.

3) A motion detector, whose sensor unit detects the presence of a bystander and then sends a signal to activate the playback of pre-recorded audio and/or video.

4) A removable, replaceable flash memory storage source, fixed flash memory storage source, or both, as a means of storing pre-recorded audio and/or video programming.

5) An audio CODEC circuitry playback unit.

6) A video clip CODEC circuitry playback unit.

7) A speaker, for output of pre-recorded sound.

8) Switches and/or pushbuttons, for manually starting or stopping the audio and/or video clip CODEC circuitry playback units.

9) A power source consisting of rechargeable, replaceable batteries and/or an AC-to-DC power supply capable of receiving AC power from a wall outlet and producing DC current as necessary, to power POP display components.

10) Audio and video outlet jacks, for feeding audio and/or video to external speakers and/or video monitors.

11) Audio and video input jacks, for displaying audio and/or video from an external source on the display's monitor and/or speaker.

12) Integrated, shelves, bins, hooks, and/or hangers, for display and dispensing of promotional materials, and/or the product itself.

In use, a bystander's approach to the display stand triggers the motion detector sensor which activates the audio and/or video CODEC circuitry playback unit which decodes, reads and plays the pre-recorded audio and/or video program from integrated or removable flash memory. Thereafter, video plays on the video monitor and/or sound emanates from the speaker. Switches and/or pushbuttons on the display stand can be utilized to restart or terminate the audiovisual program as often as the bystander or sales representative so desires. The switches and/or pushbuttons can also be utilized to end the audiovisual program, when desired.

The motion detecting sensor can be adjusted to determine at what distance a bystander is detected. Each time the motion detector detects a bystander within the pre-determined range, the motion detector activates the pre-recorded audio and/or video CODEC circuitry playback unit. Sound and/or video are then played from the speaker and video monitor either separately or in synchronization, with the audio and/or video programs repeating so long as the bystander remains present in the sensing range of the motion detector. Switches and/or pushbuttons on the display may be used by the bystander or a sales representative to stop or restart the audio and/or video programs.

The above and other aspects and advantages of the present invention will become more apparent from the following detailed description of the preferred embodiments of the present invention.

### BRIEF DESCRIPTION OF THE DRAWINGS

FIG. 1 is a perspective view of one point-of-purchase display constructed in accordance with the principles of the present invention.

### DETAILED DESCRIPTION OF THE PREFERRED EMBODIMENTS

While the present invention is susceptible of embodiment of various forms and will hereinafter be described in the form of the preferred embodiments, it should be understood that the following description of the preferred embodiments is to be considered an exemplification of the invention, and is not intended to limit the invention to the specific embodiments illustrated.

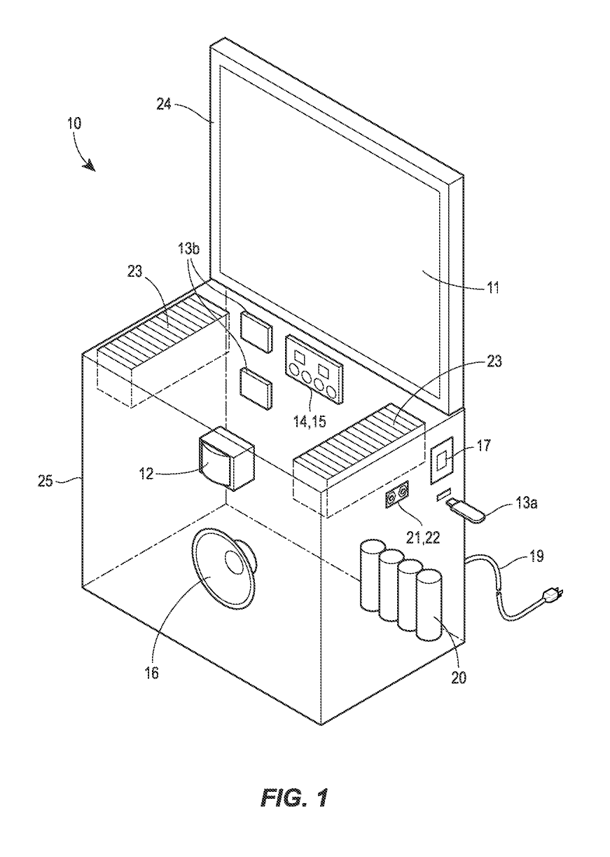

FIG. 1 depicts a POP display 10 constructed in accordance with the present disclosure. The POP display may be constructed from many different materials including plastic, poly vinyl chloride (PVC), fiberglass, reinforced durable paper products, and other durable materials. The shape and size of the POP display 10 can be varied depending upon the needs of the product and of the sales location. The sign 24 of the display consists completely or partially of a video monitor 11 and can be fabricated to any desired height and width. The sign 24 extends vertically from the top of the base stand 25 (as pictured), or may be integrated into the face of the base stand 25 for a more compact design. The base stand 25 may be equipped with one or more product storage devices 23, such as integrated bins (as shown in FIG. 1), external hooks, shelves, hangers, or any other means of holding and displaying products for sale or promotional materials, if desired. The base stand 25 also serves as an enclosure for the digital codec playback circuitry, non-volatile memory, power supply and/or batteries, and other internal components to be described later. The base stand 25 rests upright on a countertop, shelf or floor. The video monitor 11 is incorporated flush into the sign 24 of the display or, alternatively, acts in its entirety as the vertical signage of the display. When a more compact POP display is desired, the video monitor 11 may be integrated into the face of the display stand 25.

A motion sensor 12 is mounted in the front of the base stand 25. Any commonly used motion sensing device is suitable for use in the POP display; specific examples are an ultrasound electronic device, a microwave electronic device, or the preferable embodiment, which is a passive infrared (PIR) sensor. A PIR sensor is an electronic device which measures infrared radiation emanating from objects in its field of view. Motion is detected when an infrared source with a different temperature than its surroundings, such as a human bystander, enters the field of view of the PIR sensor. The resulting change in infrared radiation entering the PIR detector is sensed by electronic circuitry in the PIR sensor, causing an output relay in the PIR sensor to switch.

All objects emit what is known as black body radiation. This energy is invisible to the human eye, but can be detected by electronic devices designed for such a purpose. The term “passive” in this instance means the PIR sensor does not emit energy of any type but merely senses incoming infrared radiation emitted naturally by objects in its field of view.

Infrared radiation enters through the front of the PIR sensor (the sensor face). At the core of a PIR sensor is a solid state sensor or set of sensors, made from approximately ¼ inch squares of natural or artificial pyroelectric materials, usually in the form of a thin film of gallium nitride (GaN), cesium nitrate (CsNO₃), polyvinyl fluorides, derivatives of phenylpyrazine, or cobalt phthalocyanine. Lithium tantalate (LiTaO₃) is a crystal exhibiting both piezoelectric and pyroelectric properties.

The PIR sensor is often manufactured as part of an integrated circuit and may consist of one, two, or four pixels of equal areas of the pyroelectric material. Pairs of the sensor pixels may be wired as opposite inputs to a differential amplifier. In such a configuration, the infrared measurements cancel each other so that the average temperature of the field of view is removed from the electrical signal, but an increase of infrared energy across the entire sensor is self-canceling and will not trigger the device. This allows the PIR sensor to resist false indications of change in the event of being exposed to flashes of light or field-wide illumination.

A window covers the front face of the PIR sensor. In the PIR-based motion detector, the PIR sensor is typically mounted on a printed circuit board which also contains the necessary electronics required to interpret the signals from the chip. The complete circuit is contained in a housing which is then mounted in a location where the sensor can view the area to be monitored. The sensor is mounted in the front face of the base stand 25 with the lens protruding just past the front face of base stand 25 if the display base sits on a countertop, alternatively the PIR sensor may be mounted in the front of the sign 24 with the lens protruding just past the front face of the sign 24 to ensure the motion sensor 12 is optimally positioned to sense a bystander. Infrared energy is able to reach the sensor through the lens because the plastic used in the lens is transparent to infrared radiation (but only translucent to visible light). The lens also prevents the introduction of dust and other debris into the PIR sensor which could obscure the sensor's field of view.

A few mechanisms are used to focus infrared energy onto the sensor surface. The plastic window covering the PIR sensor may have a Fresnel lens molded into it, which is the preferred embodiment. Alternatively, the PIR sensor may be fitted with plastic segmented parabolic mirrors to focus the infrared energy; when mirrors are used, the plastic window cover has no Fresnel lenses molded into it. A filtering window (or lens) may be used to limit the infrared wavelengths entering the PIR detector to 8-14 micrometers, which makes the PIR detector most sensitive to infrared radiation from the human body (in infrared radiation emitted from the human body, 9.4 micrometers is typically the wavelength with the greatest intensity).

The PIR sensor can be thought of as a kind of infrared “camera” which remembers the amount of infrared energy focused on its surface. Once power is applied to the PIR sensor, the electronics in the PIR sensor shortly settle into a quiescent state and energize a small relay. This relay controls a set of electrical contacts which are usually connected to the detection input of an actuating or initiating control panel (“initiator”). If the amount of infrared energy focused on the sensor changes within a configured time period, the device will switch the state of the initiator output relay. The initiator output relay is typically a normally closed (NC) relay, also know as a “Form B” relay.

A person entering the area monitored by the PIR sensor is detected when the infrared energy emitted from the entering bystander's body is focused by a Fresnel lens or a mirror segment onto a section on the chip which had previously been looking at some much cooler part of the monitored area. That portion of the chip now senses more infrared radiation than when the bystander wasn't there. As the bystander moves into the PIR sensor's field of view, a “hot spot” of focused infrared radiation is projected onto the surface of the chip. When the sensor electronics detect the change in infrared radiation sensed, to the sensor electronics de-energize the output relay, operating its contacts, thereby activating the detection input on the initiator control panel, which then signals the CODEC circuitry 14, 15 to commence playback of the pre-recorded audio and/or video.

It is recommended that the PIR sensor not be placed in such a position that a heating or air conditioning vent would blow hot or cold air onto the surface of the plastic which covers the housing's window. Although air has very low emissivity (i.e. it emits very small amounts of infrared energy), the air blowing on the plastic window cover could change the plastic's temperature enough to “fool” the electronics into initiating the control panel when a bystander is not present.

Those skilled in the art know that PIR sensors come in many configurations for a wide variety of applications. Those used in home security systems have numerous Fresnel lenses or mirror segments and have an effective range of about thirty feet. Some larger PIRs are made with single segment mirrors and can sense changes in infrared energy over one hundred feet away from the PIR. There are also PIRs designed with reversible orientation mirrors which allow either broad coverage (110 degrees wide) or very narrow “curtain” coverage.

PIR sensors can have more than one internal sensing element so that, with the appropriate electronics and Fresnel lens, it can detect direction. The sensor can distinguish left to right, right to left, or up and down motion, for example, and provide an appropriate output signal as desired for display purposes.

In one embodiment, the POP display 10 may be fitted with pushbuttons or switches 17 mounted in the surface of the base stand 25, which, when pressed or otherwise operated, can override the signal from the motion sensor 12 to start or stop the audio and video CODEC circuitry and manually control the operation of the POP display 10.

One skilled in the art will realize that the pre-recorded audio and video clips stored in a memory device 13 (the preferred embodiment being flash memory) of the invention as described herein must first be recorded in a studio or other location onto a “master” memory storage device (not shown) for subsequent transfer to the memory device 13 of the POP display 10. The display may be shipped with the desired audio and video pre-recorded in an integrated flash memory storage unit 13b, or, more preferably, the programming may be changed or updated at the point of purchase using a removable, replaceable flash memory device 13a. This allows the POP display 10 to be updated as often as desired, to reflect new product features or marketing campaigns with only a convenient, easy-to-accomplish update of the audio and video programming it presents to bystanders.

In one embodiment, the pre-recorded audio and video of the present invention is copied from the master to a removable, replaceable flash memory source device 13a (such as a “memory stick”, “memory card” or “thumb drive”) that has sufficient capacity for storing digital audio and video. The removable, replaceable flash memory source device 13a may then be inserted into a receptacle (not pictured) in the base stand 25. Most preferably, the flash memory used is of a type that may be easily removed and replaced by sales personnel, such as a universal serial bus (USB) thumb drive, or one of several formats of removable flash memory used by digital cameras and other devices.

In another embodiment, the pre-recorded audio and video is copied from a removable, replaceable storage device 13a to a permanent digital flash memory storage device 13b which is integrated into the POP display 10. After materials are copied into the integrated device 13b, the removable, replaceable storage device 13a may be used to update other POP displays on the sales floor, or may be put to other uses.

In a third embodiment of the invention, a large-capacity hard disk drive (not pictured) can be built into the base of the display unit, and can be used to supplement or replace the integrated flash memory storage capacity if desired.

Digital media (as opposed to analog media) usually refers to electronic media that store pictures, video, sound, or other material encoded in digital format; i.e. as a series of binary numbers. One such device is the flash memory chip. Flash memory is non-volatile computer memory that can be electrically erased and reprogrammed. It is a technology that is primarily used in memory cards and USB “thumb drives” for general storage and transfer of data between computers and other digital products. It is a specific type of EEPROM (Electrically Erasable Programmable Read-Only Memory) that is erased and programmed in large blocks; in early flash EEPROMs, the entire chip had to be erased at once. Flash memory costs far less than byte-programmable EEPROM, and therefore has become the dominant technology wherever a significant amount of non-volatile, solid-state storage is needed. Example applications of flash memory include PDAs (personal digital assistants), laptop computers, digital audio players, digital cameras and mobile phones. It has also gained popularity in the game console market, where it is often used instead of EEPROMs or battery-powered static random access memory (SRAM) for game save data.

Flash memory is non-volatile, which means that no power is needed to maintain the information stored in the chip. In addition, flash memory offers fast read access times (although not as fast as volatile DRAM memory used for main memory in PCs) and better kinetic shock resistance than hard disks. These characteristics explain the popularity of flash memory in portable devices. Another feature of flash memory is that when packaged in a protective casing (for example, in a memory card, memory stick, or USB thumb drive), it is enormously durable, being able to withstand intense pressure, extremes of temperature, and even immersion in water. Storage capacities have reached up to 32 GB for flash memory, although a lesser storage capacity should be more than sufficient for use in this application.

Although technically a type of EEPROM, the term “EEPROM” is generally used to refer specifically to non-flash EEPROMs which are erasable in small blocks, typically bytes. Because erase cycles are slow, the large block sizes used in flash memory erasing give it a significant speed advantage over old-style EEPROMs when writing large amounts of data. For the reasons stated, flash memory is the most desirable form of digital storage for this application and is the preferred embodiment of the storage memory source 13 for use in the POP display 10.

In 1987, ISD (Integrated Storage Devices) began developing a unique record/playback technology called ChipCorder. Developing a previously unused characteristic of EEPROM memory, ChipCorder allows one to store different voltage levels, not just a binary value (one or zero) in each memory cell. The ChipCorder samples and stores the audio signal directly into the memory cells without converting the audio signal to digital values first, allowing ISD to make high quality audio recordings on a single chip. In this way, ChipCorder devices can store an audio signal with eight times as much resolution as a similarly sized digital storage device. ISD's products have seen widespread use in such applications as talking greeting cards. This type of chip memory may suffice for some applications dependent upon the size of audio modulating data to be stored and played, and can be coupled with a separate flash memory for the video clip component to be stored and played back to the observer by the POP display 10.

The first significant application of an eight-bit microprocessor was developed in Taiwan in the early 1990's. Techno Mind was involved in the development of an 8-bit CPU as early as 1992. Today, there are multiple sources for these chips, and prices continue to drop. These chips or the “ChipCorder” may suffice for audio storage, depending upon the price point desired for this component. Those skilled in the art will recognize that a variety of differing types of memory can be used in the composition of the present invention, whether it be flash memory, multiple chips, or a hard disk drive supplementing each of the foregoing memory storage sources.

In order to increase the POP display's appeal to bystanders even more, the display plays video as well as audio. Therefore, a color LCD, plasma display, OLED display, or any other type of video monitor is also a component of the POP display. A liquid crystal display (LCD) is a thin, flat display device made up of any number of color or monochrome pixels arrayed in front of a light source or reflector. It is often utilized in battery-powered electronic devices because it uses very small amounts of electric power. An organic light-emitting diode (OLED) display, also known as a light emitting polymer (LEP) or organic electro-luminescence (OEL) display, consists of light-emitting diodes (LEDs) whose emissive electroluminescent layer is composed of a film of organic compounds. The layer usually contains a polymer substance that allows suitable organic compounds to be deposited. The OLEDs are deposited in rows and columns onto a flat carrier by a simple “printing” process. The resulting matrix of pixels can emit light of different colors.

Those skilled in the art will know that a variety of differing types of video monitors can be used in the POP display. One such type is the thin film transistor liquid crystal display (TFT-LCD). TFT-LCD is a variant of the LCD screen which uses thin film transistor (TFT) technology to improve image quality. An active matrix liquid crystal display (AMLCD) is another type of flat panel display. AMLCD is the current overwhelming choice of notebook computer manufacturers, due to light weight, very good image quality, wide color gamut, and good response time. Thus, variants of LCD, plasma, or OLED technology allow for the best combination of image quality, compact size, and minimal power consumption, as one skilled in the art realizes.

Such systems are used today in television screens, computer displays, portable system screens, and advertising. OLEDs can also be used as light sources for general space illumination, and large-area light-emitting elements. OLEDs typically emit less light per area than inorganic LEDs, which are usually used as point light-emitting elements.

A significant benefit of an OLED display over traditional liquid crystal displays (LCDs) is that OLEDs do not require a backlight to function. Thus, they draw far less power and, when powered from a battery, can operate longer on the same charge. Because there is no need for a backlight, an OLED display can be much thinner than a LCD panel. OLED-based display devices also can be simpler to manufacture than LCDs and plasma displays. However, the limited lifetime of currently available OLED materials has somewhat limited their use.

A CODEC is a device or program capable of encoding and/or decoding a digital data stream or signal. The word “CODEC” may be a combination of any of the following: “COmpressor-DECompressor”, “COder-DECoder”, or “COmpression/DECompression algorithm”.

Another component of the invention is an embedded processor 14 with an audio CODEC microchip to convert digitally compressed sound stored in memory 13 into analog form that is then played through the speaker 16. Similarly, the stored component video is a video signal that has been split into two or more components. In popular use, “component video” refers to a type of analog video information that is transmitted or stored as three separate signals. The stored composite video in the invention is often designated by the CVBS acronym, meaning any of “Color, Video, Blank and Sync”, “Composite Video Baseband Signal”, “Composite Video Burst Signal”, or “Composite Video with Burst and Sync”. The video that is stored and played back in the instant invention is a combination of component and composite video, and the video data is stored in the flash memory component of the invention.

In one embodiment, a CODEC format such as Windows Media Video (“WMV”), or H.264/MPEG-4 AVC, or similar CODEC is utilized. H.264 is a standard for video compression. It is also known as MPEG-4 Part 10, or MPEG-4 AVC (for Advanced Video Coding). It is the preferred embodiment and is one of the latest block-oriented motion-estimation-based CODECs developed by the ITU-T Video Coding Experts Group (“VCEG”) together with the ISO/IEC Moving Picture Experts Group (“MPEG”) as the product of a partnership effort known as the Joint Video Team (“JVT”). The ITU-T H.264 standard and the ISO/IEC MPEG-4 Part 10 (formally, ISO/IEC 14496-10) standard are jointly maintained so that they have identical technical content. Those skilled in the art will recognize that it is possible for multiple CODECs to be used in the present invention, avoiding the need to choose a single dominant CODEC for compatibility reasons. Widely-used video CODECs are possible candidates for use in the POP display. The ones specified in international standards and the ones preferred by current trends in the art are to be supported in the preferred embodiment of the POP display 10. The current trend and, therefore, the preferred embodiment of the invention, is the MPEG-4 Part 10 (a standard technically aligned with the ITU-T's H.264, and often also referred to as AVC). This emerging new standard is the current state of the art of ITU-T and MPEG standardized compression technology, and is rapidly gaining adoption in a wide variety of applications. It contains a number of significant advances in compression capability, and it has recently been adopted into a number of consumer products, including, for example, the XBOX 360, PlayStation Portable, iPod, iPhone, the Nero Digital product suite, Mac OS X v10.4, as well as HD-DVD and Blu-ray Disc.

One of the preferred embodiment CODECs of the invention is H.264/AVC/MPEG-4 Part 10, which contains a number of new features that allow it to compress video much more effectively than older standards and to provide more flexibility for application to a wide variety of network environments. Those skilled in the art will recognize that it is possible for multiple CODECs to be used in the present invention, avoiding the need to choose a single dominant CODEC for compatibility reasons as well as for cost consideration.

The power source of the invention consists of rechargeable, replaceable batteries 20 and/or a power cord 19 capable of receiving AC current from a standard outlet. An AC to DC power supply (not pictured) can supply power, as required, to POP display components. Most preferably, the POP display 10 has both rechargeable, replaceable batteries 20 and a power cord 19 such that it can use AC power to recharge the batteries in between uses.

Audio and video input 22 and output 21 connections may be provided on the POP display 10 as well. These inputs and outputs can be of any industry standard format commonly used for interconnecting such equipment and passing audio and video signals. Audio and video output jacks allow the audio and/or video programs produced by the POP display to be heard and/or shown on external speakers and/or monitors. This could be useful when the POP display is used in a busy or noisy location. Audio and video input jacks can be used for testing the POP display components, or for playback of an audio and/or video signal from an external source, such as a DVD player, computer, or any other external signal source.

In summation, the invention consists of the motion- or switch-activated audio/video display components as stated. A motion detector 12 detects a bystander within a designated range of the POP display 10. Upon sensing the bystander, the motion detector 12 actuates the audio CODEC circuitry 14 and/or video CODEC circuitry 15 which play back the program recorded digitally in memory 13 over the video monitor 11 and speaker 16, using one or more industry-standard CODECs. The digital media playback can be programmed to be solely a pre-recorded audio clip, solely pre-recorded video clips, or pre-recorded video with a soundtrack. Portable, external and detachable flash memory storage 13a allows for updating of the POP display 10 at the point of purchase or even serves as the POP display's sole source of memory, and the power source can be either removable, replaceable batteries 20 or an AC power cord 19, which draws AC power that can be converted to the desired form necessary for the components of the display. One skilled in the art will recognize that variations of the component elements are possible with the advent of improving technologies pertaining to motion detectors, switches, memory chips, microprocessors, and CODEC innovations, resulting in improved pricing of digital media storage chips, microprocessors, and playback components. With component technology improvements comes improvements in the audio and video qualities. Additionally these improvements in the components of the invention result in a more condensed and lighter display unit as well as reduced cost for the components described herein.

Likewise, those skilled in the art will recognize that a variety of differing types and sizes of motion detectors, memory chips, microprocessors, and CODEC devices can be used in the composition of the present invention and therefore from the foregoing it will be observed that numerous modifications and variations can be effectuated without departing from the true spirit and scope of the novel concepts of the present invention.

It is to be understood that no limitation to a particular embodiment described in this specification is intended or should be inferred.

1. A self-contained point-of-purchase sales device comprising:
a display;
a video monitor integrated into the display;
a speaker integrated into the display;
a CODEC digital media playback device integrated within the display and having electrical outputs coupled to the video monitor and speaker, the CODEC digital media playback device for playing back video and audio;
a memory device integrated within the display and electrically coupled to the CODEC digital media playback device, the memory device storing video and audio program materials; and
an electronic sensor integrated within the display and for detecting a nearby bystander, the electronic sensor electrically coupled to the CODEC digital media playback device for triggering the playback of video and audio program materials when a bystander approaches the display.

2. The point-of-purchase sales device of claim 1, further comprising a power source that comprises rechargeable electrical storage batteries.

3. The point-of-purchase sales device of claim 1, further comprising a power source that comprises alternating current electricity supplied by a wall outlet.

4. The point-of-purchase sales device of claim 1, wherein the memory device comprises a permanently installed, solid-state nonvolatile digital storage device.

5. The point-of-purchase sales device of claim 1, wherein the memory device comprises a removable, replaceable nonvolatile digital storage device.

6. The point of purchase sales device of claim 1, wherein the memory device comprises a hard disk drive.

7. The point-of-purchase sales device of claim 1, wherein the sensor for detecting a bystander comprises a passive infrared sensor.

8. The point-of-purchase sales device of claim 1, wherein the sensor for detecting a bystander comprises an ultrasound sensor.

9. The point-of-purchase sales device of claim 1, wherein the video monitor comprises a liquid crystal display.

10. The point-of-purchase sales device of claim 1, wherein the video monitor comprises an organic light-emitting diode display.

11. (canceled)

12. The point-of-purchase sales device of claim 1, further comprising a manually operated control device, electrically coupled to the digital media playback device, for manual control of audio and video program playback.

13. The point-of-purchase sales device of claim 1, further comprising a signal output device to allow connection of an external video monitor to the output of the digital media playback device.

14. The point-of-purchase sales device of claim 1, further comprising a signal output device to allow connection of an external speaker to the output of the digital media playback device.

15. The point-of-purchase sales device of claim 1, further comprising a signal input device to allow playback of an external video signal source on the video monitor of the POP display.

16. The point-of-purchase sales device of claim 1, further comprising a signal input device to allow playback of an external audio signal source on the speaker of the POP display.

17. (canceled)

18. (canceled)

19. A self-contained point-of-purchase sales device comprising:
a display;
an output device integrated into the display;
a CODEC digital media playback device integrated within the display and having electrical outputs coupled to the output device;
a memory device integrated within the display and electrically coupled to the digital media playback device, the memory device storing a digital media program; and an electronic motion sensor device integrated into the display and coupled to the digital media playback device, the electronic motion sensor for initiating the CODEC digital media playback device to playback digital media that is stored in the memory device within the display upon sensing motion of a bystander.

20. The point-of-purchase sales device of claim 19, wherein the output device comprises at least one of a video monitor and a speaker.

21. The point-of-purchase sales device of claim 20, wherein the output device further comprises at least one of a liquid crystal display, a plasma display and an organic light emitting diode display.

22. (canceled)

23. The point-of-purchase sales device of claim 19, wherein the memory device comprises at least one of a permanently installed, solid-state nonvolatile digital storage device, and a hard disk drive.

24. (canceled)

25. (canceled)

26. (canceled)

27. The point-of-purchase sales device of claim 19, further comprising a product storage device integrated into the display and storing products offered for sale.
